(19) United States
(12) Patent Application Publication
(10) Pub. No.: US 2011/0166264 A1
(43) Pub. Date: Jul. 7, 2011

(54) NITRILE BUTADIENE STYRENE TERPOLYMERS

(75) Inventors: Deepak Rasiklal Parikh, Beaumont, TX (US); Robert Stephen Rikhoff, Prairieville, LA (US); Lawrence Douglas Harris, Baton Rouge, LA (US); Vernon Vincent Vanis, Spring, TX (US)

(73) Assignee: LION COPOLYMER, LLC, Baton Rouge, LA (US)

(21) Appl. No.: 12/984,311

(22) Filed: Jan. 4, 2011

Related U.S. Application Data
(60) Provisional application No. 61/292,927, filed on Jan. 7, 2010.

(51) Int. Cl. C08L 55/02; C08K 11/00; C08K 5/13; C08K 5/17; C08L 9/02; C08L 9/06; C08F 236/06; C08K 3/34; C08K 3/26

(52) U.S. Cl. 524/15; 524/565; 524/65; 524/35; 524/343; 524/323; 524/251; 526/338; 524/451; 524/445; 524/426

(57) ABSTRACT

An elastomeric thermoplastic non-vulcanized terpolymer composition formed from acrylonitrile, styrene, and liquid 1,3-butadiene is disclosed herein. The terpolymer can have from 20 percent by weight to 50 percent by weight of the acrylonitrile, from 0.5 percent by weight to 20 percent by weight of the styrene, and from 30 percent by weight to 79.5 percent by weight of the butadiene. The acrylonitrile can be cross-linked to the styrene. The thermoplastic non-vulcanized terpolymer can include fillers, UV stabilizers, and plasticizers. Also disclosed is an article formed by the elastomeric thermoplastic non-vulcanized terpolymer and a process for making the composition.

### CROSS REFERENCE TO RELATED APPLICATIONS

The present application claims priority to and the benefit of U.S. Provisional Patent Application Ser. No. 61/292,927 filed on Jan. 7, 2010, entitled “NITRILE BUTADIENE STYRENE TERPOLYMERS”. This reference is hereby incorporated in its entirety.

### FIELD

The present embodiments generally relate to a nitrile butadiene styrene terpolymer containing silica for ease of recycling and lower cost manufacturing and a method for making the terpolymer.

### BACKGROUND

A need exists for a terpolymer that can be used at higher service temperatures.

A need exists for a terpolymer with improved chemical resistance to hydrocarbon degradation, improved low temperature properties, such as brittleness, and improved flexible strength.

A need exists for a terpolymer that has lower manufacturing costs than similarly produced terpolymers.

The present embodiments meet these needs.

### BRIEF DESCRIPTION OF THE FIGURE

FIG. 1 is a flow diagram of a method for making the terpolymer.

### DETAILED DESCRIPTION OF THE EMBODIMENTS

Before explaining the present terpolymer and the method for making the terpolymer, it is to be understood that the terpolymer and the method are not limited to the particular embodiments and can be practiced or carried out in various ways.

The present embodiments generally relate to an elastomeric terpolymer and a method for making the elastomeric terpolymer.

“Elastomeric terpolymer”, as the term is used herein, refers to a polymer with the property of viscoelasticity or elasticity, generally having a notably low Young's modulus and a high yield strain compared with other materials. “Elastomeric terpolymer”, which is derived from elastic polymer, is often used interchangeably with the term rubber, although the latter is preferred when referring to vulcanisates. Each of the monomers that link to form the terpolymer can be made, at least in part, of carbon, hydrogen, oxygen, and/or silicon.

Elastomers are amorphous polymers existing above their glass transition temperature, such that considerable segmental motion is possible. At ambient temperatures rubbers are thus relatively soft and deformable, with E+3 Mpa. Primary uses of rubbers include seals, adhesives, molded flexible parts, and the like.

A “terpolymer”, as the term is used herein, refers to a polymer consisting of three distinct monomers. In particular, the three distinct monomers discussed herein can include acrylonitrile, styrene, and butadiene. The butadiene can be 1,3-butadiene, which can be liquid 1,3-butadiene. The terpolymer can be an elastomeric thermoplastic non-vulcanized terpolymer.

The elastomeric terpolymer can include a backbone of carbon bonds between the three distinct monomers in a continuous chain, which can form the elastomeric terpolymer.

The terpolymer can be an acrylonitrile butadiene styrene terpolymer. One or more embodiments relate to an article made from the terpolymer.

The elastomeric terpolymer can be an elastomeric randomly branched terpolymer.

The elastomeric terpolymer composition can include from about 10 percent by weight to about 50 percent by weight of acrylonitrile, from about 0.5 percent by weight to about 20 percent by weight of styrene, and from about 30 percent by weight to about 89.5 percent by weight of a butadiene.

An illustrative embodiment of the elastomeric terpolymer composition can include from about 25 percent to about 45 weight percent of acrylonitrile or from about 30 percent to about 40 weight percent of acrylonitrile. The terpolymer can include from about 1 percent to about 10 weight percent of styrene, and from about 45 percent to about 74 weight percent of butadiene.

The terpolymer can be formed with 5 weight percent of acrylonitrile, 5 weight percent of styrene, and 65 weight percent of butadiene.

The monomers can be in liquid form for emulsion polymerization of the monomers.

In embodiments, the terpolymer can be formed as an elastomeric randomly branched terpolymer having a ratio of acrylonitrile to styrene from 3:1 to 8:1, and a ratio of styrene to butadiene from 0.06:1 to 0.14:1. The terpolymer can be formed as an elastomeric randomly branched terpolymer having a ratio of butadiene to styrene from 7:1 to 14:1, and a ratio of acrylonitrile to butadiene of 0.4:1 to 0.75:1. The terpolymer can be formed as an elastomeric randomly branched terpolymer having a ratio of butadiene to acrylonitrile from 1.3:1 to 2.5:1.

The resultant terpolymer can provide a tensile strength of at least 21 MPa and a flexibility at temperatures as low as negative 30 degrees Celsius. The resultant terpolymer can provide a resistance to degradation and swelling when in contact with liquid diesel fuel and other liquid non-polar solvents. The resultant terpolymer can have a compression set for resistance to deformation at temperatures up to 100 degrees Celsius, a modulus of at least 9 megapascals +/−2 megapascals, and a tear strength of 200 ft/lb inch.

The terpolymer can be formed from an emulsion polymerization reaction occurring at 5 degrees Celsius to 10 degrees Celsius. The emulsion polymerization reaction can use soap, a free radical initiator, a mercaptan, an activator to chemically trigger the free radical initiator under an inert gas, and a terminating agent to stop long chain polymerization from continuing.

The emulsions polymerization with the liquid butadiene monomer can occur at temperatures as low as 1 degree Celsius and up to 25 degrees Celsius.

The emulsion polymerization can be continuous and occur at a flow rate of up to 150 gallons per minute.

Elastomeric terpolymers can be used for creating articles that can withstand greater impact and repeated load impact without significant deformation.

The elastomeric terpolymer can be used at higher service temperatures, such as at service temperatures up to 190 degrees Celsius. The elastomeric terpolymer can be used at higher service temperatures, in part because of the styrene content.

The present elastomeric terpolymer can include lower levels of additives than other copolymers, while maintaining similar properties to the other copolymers in a variety of climates.

Terpolymers, such as those having 1,4-diketo functionalities and a carbonyl group concentration of about 5 percent to about 20 percent of polymer weight, can be conveniently cured by heating with an aromatic primary diamine or its precursor and a catalytic amount of an acid having a pKa of about 3 or less.

Cured terpolymers can have good physical properties and be suitable for use in, for example, hoses, tubing, wire coatings, gaskets, and seals. The elastomeric terpolymers can have improved chemical resistance. For example, the elastomeric terpolymer can resist damage from chemical reactivity and solvent action from turpentine, oils, and other hydrocarbons.

The elastomeric terpolymer described herein can have a longer useful life span than other elastomeric terpolymers due, at least in part, to its improved durability.

The elastomeric terpolymer can be less expensive to manufacture than other elastomeric terpolymers. For example, the elastomeric terpolymer can be manufactured at a cost which is 2.7 percent lower than NBR 35-5. The elastomeric terpolymer can be less expensive to manufacture than other elastomeric terpolymers, at least in part, because substitution of lower cost styrene monomer is possible.

In one or more embodiments, the monomers, including acrylonitrile, styrene, and butadiene, can be covalently bonded together to form the elastomeric terpolymer of acrylonitrile, styrene, and butadiene. As such, carbon atoms of the acrylonitrile, styrene, and butadiene can form a carbon chain as a backbone of the elastomeric terpolymer.

Acrylonitrile is a chemical compound having the formula CH₂═CHC≡N.

Styrene, also known as vinyl benzene, is an organic chemical compound having a formula of C₆H₅CH═CH₂.

The butadiene can be a 1,3-butadiene with a chemical compound having the formula of CH₂═CHCH═CH₂.

In one or more embodiments, the elastomeric terpolymer can have a reactivity ratio between the monomers of 2:4. For example, the reactivity ratio between acrylonitrile and styrene can be about equal, 1:1, and the reactivity ratio between acrylonitrile and butadiene can be about equal, 1:1. The reactivity ratio between butadiene and styrene can be about equal as well, 1:1.

In one or more embodiments, less than about 50 percent of the elastomeric terpolymer can have an occurrence of two styrene molecules adjacent to each other as determined by nuclear magnetic resonance (NMR).

The elastomeric terpolymer can have an average elastomeric terpolymer chain length from about 5,000 monomer units to about 200,000 monomer units per chain. Each chain of the elastomeric terpolymer can have an average molecular weight from about 40,000 to about 1,000,000.

The butadiene monomer of the terpolymer can be cross-linked with other butadiene monomers within the elastomeric terpolymer, such as with covalent bonds, ionic bonds, or combinations thereof.

The elastomeric terpolymer composition can have 100 percent covalent bonding. The monomers of the terpolymer can be cross-linked covalently.

The elastomeric terpolymer can have fillers. For example, the filler can include ground pecan shells, diamataeous earth, silica, treated silica such as compatiblized silica, silage, cellulosic materials, ground peanut shells, talc, ground coal, ground bagasse, ash, perlite, clay, calcium carbonate, biomass, carbon black, or combinations thereof.

In one or more embodiments, carbon black can be included in the formation, such that an amount of the carbon black varies from about 0.1 percent to about 40 percent by weight of the monomers.

The filler can be used in amounts up to 50 percent by weight of the monomers, that is, 50 percent by weight filler based on the total monomer weight percent.

The elastomeric terpolymer can include antioxidants, ultraviolet (UV) stabilizers, extender oils, or combinations thereof. Form about 0.05 percent to about 50 percent by weight of a combination of antioxidants, ultraviolet stabilizers, and extender oils can be used with the terpolymer. From about 0.1 percent by weight to about 5 weight percent of the combination of ultraviolet stabilizer and antioxidant can be used. Either or both of the antioxidant and the ultraviolet stabilizers can be used in a range from about 0.1 percent to about 5 percent by weight.

The antioxidants can include a phenolic antioxidant, a phosphite, bis phenol, an amine, or combinations thereof. From about 0.01 percent to about 5 percent by weight of the antioxidant can be used based on the total weight of the monomers.

The ultraviolet stabilizer can be a hindered amine.

The extender oil can be a synthetic oil, an aromatic oil, a naphthenic oil, a hydrocarbon based oil, a polycyclic aromatic hydrocarbon oil, or combinations thereof.

From about 0.01 percent to about 50 percent by weight of extender oil can be used based on the total weight of the monomers. In one or more embodiments, an amount of extender oil range from about 0.1 percent to about 40 percent by weight can yield a more durable product.

An article can be made of, or formed from, the elastomeric terpolymer. Articles made of or formed from the above described elastomeric terpolymer can include: tires, belts, non-latex gloves, rollers, gasket printer's rollers, o-rings, automotive transmission belts, shoes, footwear, wire and cable jacketing, roof edging, tubular hoses, such as a garden hoses, marine impact bumpers, such as a side bumpers used for docking boats, industrial belts, non-automotive tires, mining belts, bearings, gas masks, conduit, pneumatic tires used on bikes, cars, or airplanes, and other articles.

In one or more embodiments, the elastomeric terpolymer can be made by adding up to 28 percent by weight of acrylonitrile to a nitrogen purged reactor, such as a glass bottle reactor or another similar sealable vessel that can sustain a small pressure, such as up to 2.5 bar.

### Example 1

An illustrative example of making the terpolymer is herein described.

Within a vessel, such as a glass bottle reactor under nitrogen, about 67 percent by weight of a liquid butadiene monomer can be added to the nitrogen purged reactor along with an acrylonitrile monomer.

About 5 percent by weight of styrene can be added to the liquid butadiene.

Emulsification can be started by adding twice as much water as the monomers into the vessel.

A soap can be added to the vessel, such as about 4.5 percent by weight based on the amount of monomer. The soap can be a fatty acid soap, such as E-73.

A free radical initiator of pinane hydroperoxide can be added to the vessel in an amount of about 0.065 percent by weight based on the amount of monomer.

A dodecyl mercaptan can be added to the vessel in an amount of about 0.36 percent by weight based on the amount of water in the vessel. The mercaptan can be the terminating agent, and can be added after polymerization is substantially complete. As such, the mercaptan can stop the formation of long chain polymers.

At a chemical plant, using a continuous process feed, polymerization, and termination process, the vessel can be pressurized under nitrogen to about 50 psi.

The contents of the vessel can be agitated, such as with bladed impellers or with a plurality of jet nozzles, creating an emulsion for about ½ hour.

Next, an activator can be injected into the vessel, such as up to 2.56 percent by weight of the activator based on the total amount of fluid in the vessel. The activator can be an iron sulfate. The iron sulfate can be in water and injected at a ratio of 1 part of the activator per 6.5 parts of a free radical initiator to initiate a polymerization reaction.

Mixing can occur after injection of the activator to polymerize the monomers, forming a latex with emulsified solids.

After mixing, the latex with emulsified solids can be analyzed for a predefined quantity of solids in the latex.

After analysis, the polymerization reaction can be terminated with a reaction terminator, such as diethyl hydroxyl amine in combination with sodium dimethyl dithio carbamate, with amine being at a ration of 1:1 to the carbamate.

After the polymerization reaction is terminated, pressure can be released from the vessel.

Next, unreacted monomers can be stripped from the latex using steam that can be passed around but not through the latex, such as at a temperature of about 60 Celsius.

Next, water can be separated from the latex by coagulating the latex with an alum. The latex can float and be skimmed off. The remaining fluid can flow to a second tank as waste.

The alum can precipitate emulsified solids from the coagulated latex as elastomeric randomly branched terpolymers of styrene, butadiene, and acrylonitrile with improved tensile strength of 21 MPa, improved flexibility at temperatures down to −30 Celsius, improved ability to seal at temperatures to down to −30 Celsius, improved resistance to degradation and swelling in the presence of diesel fuel and other hydrocarbons, reduced compression set for resistance to deformation at temperatures of up to 100 Celsius, an improved modulus of 9 MPa, and improved tear strength reflecting of 200 ft/lb per inch.

In embodiments, the activator can be a two bag activator, including ferrous sulfate, cobalt or manganese, or combinations thereof. The activator can cause the initiator to react and form free radicals.

In a continuous flow chemical plant, the polymerization reaction can occur in the reactor vessel at a temperature from about 5 degrees Celsius to about 7.22 degrees Celsius. The polymerization can occur in the reactor at a pressure of about 50 psi.

During the polymerization reaction, the components within the reaction vessel, such as the monomers and the activator, can be stirred, mixed, agitated, or combinations thereof.

The result of the polymerization reaction can be the production of the elastomeric terpolymer. After the polymerization reaction has completed, the elastomeric terpolymer can be removed from the vessel.

The produced elastomeric terpolymer can be used to make an article with the elastomeric terpolymer.

The term “randomly branched”, as used herein, refers to a polymeric molecules randomly attached to the main polymer molecule between a start and end point of the main polymer molecule.

The volume of the reactor can be from about 50 ml to about 50,000 gallons.

Successive batches of the activator can be added to the reactor vessel until the desired elastomeric terpolymer is produced. In one or more embodiments, the entire polymerization reaction can occur in a time period ranging from about 6 hours to about 8 hours, after which the reaction can be quenched with DEHA (N,N-Diethylhydroxylamine). An antioxidant can be added to recovered latex.

The polymerization reaction can occur in the vessel at a temperature from about 1 degree Celsius to about 25 degrees Celsius. The polymerization can occur in the vessel at a pressure from about 0.1 to about 10 atm. The polymerization can occur in the reactor at ambient pressure.

During the polymerization reaction, the components within the vessel, can be stirred, mixed, agitated or combinations thereof. For example, a moderate to slow shaking type of agitation can be used to agitate the components within the reactor.

### Example 2

A nitrile butadiene styrene terpolymer can be prepared by mixing 104.3 g of liquid butadiene, 10.9 g of styrene, and 85.9 g of acrylonitrile in a one liter polymerization bottle purged with butadiene gas, forming a monomer mixture.

Water and dodecyl mercaptan, as molecular weight control agent, can be added to the monomer mixture. For example, about 334 mL of water and about 2.75 g of dodecyl mercaptan can be added.

A solution of 6.0 mL pinane hydroperoxide can be added to the monomer mixture.

A fatty soap solution, such as about 61.54 g of the fatty soap solution with 10 percent solids, can be added to the monomer mixture.

The bottle can then be capped and attached to a rotating tumbler which can spin the bottle within a constant temperature water bath at about 7.2 degrees Celsius. The rotating tumbler can rotate at a speed of about 10 rpm.

After 30 minutes of rotation, the monomer mixture can be allowed to emulsify. The bottle can be pulled from the water bath and 6.25 g of an activator containing 0.256 percent iron can be injected through the bottle cap into the monomer mixture. The bottle can be reattached to the tumbler and spun.

After 1 hour, a sample can be collected from the bottle to determine the amount of solids and for completion of the polymerization process as an emulsification polymerization.

Sampling from the bottle can be continued hourly until a target solids amount is reached, which can take from about 6 hours to about 8 hours.

Then, 15.9 mL of a mixture of DEHA (diethyl hydroxylamine) and sodium dimethyl dithiocarbamate can be added as a terminating agent to stop the reaction. The bottle can be agitated for another 30 minutes by tumbling to ensure that the reaction has terminated.

Pressure can then be carefully released from the bottle through the cap, and contents of the bottle can be poured into a steam stripper to remove unreacted monomers.

Latex can be recovered and analyzed therefrom. The amount of acrylonitrile incorporated into the polymer can be determined by nitrogen analysis.

In an illustrative embodiment, two separate samples made with the same initial recipe had 38.6 percent to 40 percent of acrylonitrile. The two samples had an ML (1=4) at 100 degrees Celsius of 55.3 and 59.2. The two samples had a Moony stress relaxation (t.sub.80) of 5.58 and 7.56 seconds, and a delta Mooney of −23.3 and −25.3.

### Example 3

A nitrile butadiene styrene terpolymer can be prepared by mixing 130.9 g of liquid butadiene, 13.9 g of styrene, and 56.3 g of acrylonitrile in a one liter polymerization bottle purged with butadiene gas, forming a monomer mixture.

Water and dodecyl mercaptan, as molecular weight control agent, can be added to the monomer mixture, such as about 334 mL of water and 2.58 g of dodecyl mercaptan.

A solution of 6.0 ml pinane hydroperoxide can be added to the monomer mixture.

A fatty soap solution, such as about 61.54 g with 10 percent solids, can be added to the monomer mixture.

The bottle can be capped and attached to a rotating tumbler which can spin the bottle in a constant temperature water bath of about 7.2 degrees Celsius. The rotating speed of the rotating tumbler can be about 10 rpm.

After 30 minutes of rotation, the monomer mixture can be allowed to emulsify. The bottle can be pulled from the water bath, and 6.25 g of an activator containing 0.256 percent iron can be injected through the bottle cap into the monomer mixture. The bottle can be reattached to the rotating tumbler and spun again.

After 1 hour, a sample can be collected from the bottle to determine the amount of solids and for completion of the polymerization process as an emulsification polymerization.

Sampling can be continued hourly until a target solids amount is reached, which can take from about 6 hours to about 8 hours.

Then, 15.9 mL of a mixture of DEHA (diethyl hydroxylamine) and sodium dimethyl dithiocarbamate can be added as a terminating agent to stop the reaction. The bottle can be agitated for another 30 minutes by tumbling to ensure that the reaction is terminated.

Pressure can be carefully released from the bottle through the cap, and contents of the bottle can be poured into a steam stripper to remove unreacted monomers. Latex can be recovered and analyzed. The amount of acrylonitrile incorporated into the polymer can be determined by nitrogen analysis.

In an illustrative embodiments, two separate samples made with the same initial recipe had 29.9 percent and 30.5 percent acrylonitrile incorporated. The two samples had an ML (1=4) at 100 degrees Celsius of 37.6 and 34.1. The samples had a Moony stress relaxation (t.sub.80) of 4.92 and 3.96 seconds and a delta Mooney of −14.4 and −14.2.

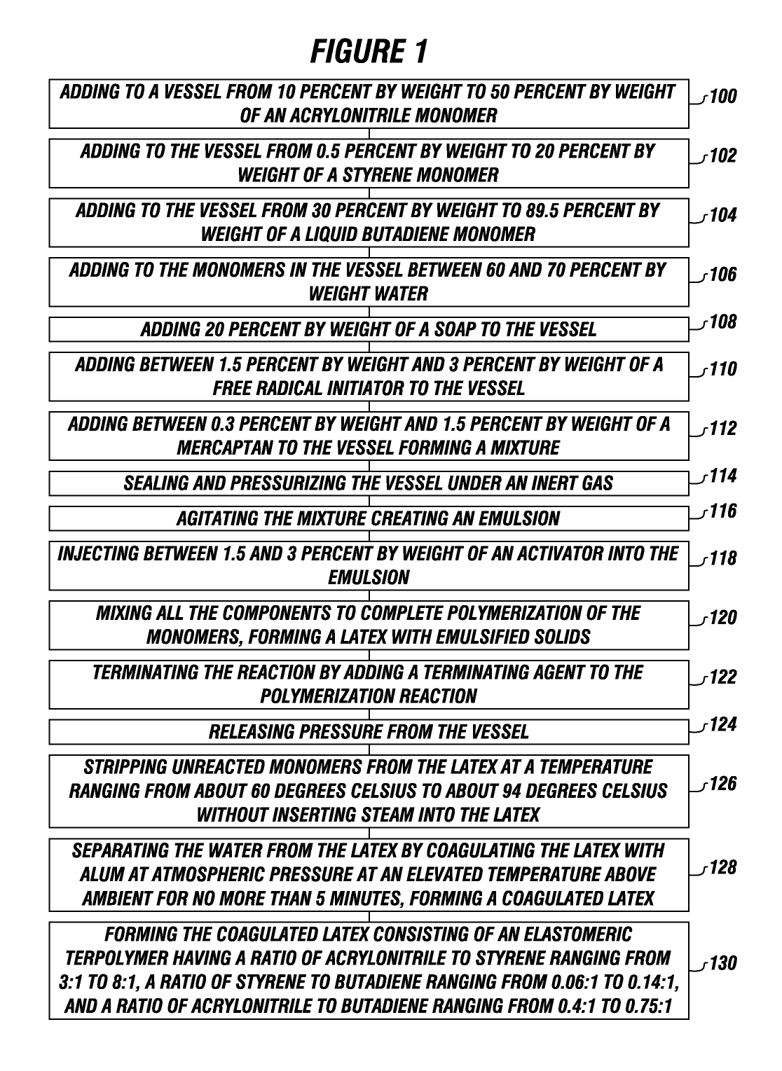

FIG. 1 is a flow diagram of a process usable to make the terpolymer.

The process can use an emulsion polymerization processes at a temperature from about 1 degree Celsius to about 15 degrees Celsius, a free radical initiator, monomers of styrene, monomers of butadiene, monomers of acrylonitrile, an activator, and a terminating agent to stop long change polymerization.

The process can include adding to a vessel from 10 percent by weight to 50 percent by weight of an acrylonitrile monomer, as illustrated by box 100.

The process can include adding to the vessel from 0.5 percent by weight to 20 percent by weight of a styrene monomer, as illustrated by box 102.

The process can include adding to the vessel from 30 percent by weight to 89.5 percent by weight of a liquid butadiene monomer, as illustrated by box 104.

The process can include adding to the monomers in the vessel between 60 percent and 70 percent by weight water, as illustrated by box 106. The weight percent of water can be based on the weight percent total of the acrylonitrile, styrene, and liquid butadiene monomers.

The process can include adding 20 percent by weight of a soap to the vessel, as illustrated by box 108. The weight percent of the soap can be based on the amount of water in the vessel.

The process can include adding between 1.5 percent by weight and 3 percent by weight of a free radical initiator to the vessel, as illustrated by box 110. The weight percent of the free radical initiator can be based on the amount of water in the vessel.

The process can include adding between 0.3 percent by weight and 1.5 percent by weight of a mercaptan to the vessel forming a mixture, as illustrated by box 112. The weight percent of the mercaptan can be based on the amount of water in the vessel.

The process can include sealing and pressurizing the vessel under an inert gas, as illustrated by box 114. The inert gas can be nitrogen, and the vessel can be pressurized to a pressure ranging from about 40 psi to about 60 psi.

The process can include agitating the mixture creating an emulsion, as illustrated by box 116.

The process can include injecting between 1.5 percent and 3 percent by weight of an activator into the emulsion, as illustrated by box 118. Less than about 1 percent by weight activator based on the weight of the emulsion can be a salt in water. The salt can contain cobalt, manganese, iron, or combinations thereof. The salt can be added to the emulsion in a 1:1 ratio with the free radical initiator to trigger a polymerization reaction between the monomers.

The process can include mixing all of the components to complete polymerization of the monomers, forming a latex with emulsified solids, as illustrated by box 120.

The process can include terminating the reaction by adding a terminating agent to the polymerization reaction, as illustrated by box 122.

The process can include releasing pressure from the vessel, as illustrated by box 124.

The process can include stripping unreacted monomers from the latex at a temperature ranging from about 60 degrees Celsius to about 94 degrees Celsius without inserting steam into the latex, as illustrated by box 126.

The process can include separating the water from the latex by coagulating the latex with alum at atmospheric pressure at an elevated temperature above ambient for no more than 5 minutes, forming a coagulated latex, as illustrated by box 128.

The process can include forming the coagulated latex consisting of an elastomeric terpolymer having a ratio of acrylonitrile to styrene ranging from 3:1 to 8:1, a ratio of styrene to butadiene ranging from 0.06:1 to 0.14:1, and a ratio of acrylonitrile to butadiene ranging from 0.4:1 to 0.75:1, as illustrated by box 130. The terpolymer can be formed from an emulsion polymerization reaction occurring at a temperature ranging from about 5 degrees Celsius to about 15 degrees Celsius.

In one or more embodiments, the process can include from 30 percent by weight to 40 percent by weight of the acrylonitrile, using up to 50 percent by weight of a filler, using only from 0.1 percent by weight to 40 percent by weight of an extender oil, using from 0.1 percent by weight to 5 percent by weight of an ultraviolet stabilizer, an antioxidant, or combinations thereof, using from 0.1 percent by weight to 40 percent by weight of carbon black, using as the free radical initiator pinane hydroperoxide, using as the activator a ferrous sulfate, using a dodecyl mercaptan as the terminating agent to stop long change polymerization, using nitrogen as the inert gas, performing the agitation over a time interval ranging from 10 minutes to ½ hour at a low temperature of between 5 degrees Celsius and 15 degrees Celsius, and analyzing the polymerized material periodically during the polymerization reaction to assure homogenous blending occurs and achieving a target solids in the latex. A target solids amount can be 23 percent.

One or more embodiments can include using diethyl hydroxyl amine as the terminating agent, using a pressure between 30,000 psi and 50000 psi as the elevated pressure, and using a temperature between 80 degrees Celsius and 140 degrees Celsius as the elevated temperature. In embodiments, the emulsion polymerization can be a continuous flow polymerization that uses a flow rate of up to 150 gallons per hour.

While these embodiments have been described with emphasis on the embodiments, it should be understood that within the scope of the appended claims, the embodiments might be practiced other than as specifically described herein.

What is claimed is:

1. An elastomeric randomly branched thermoplastic non-vulcanized terpolymer composition comprising:
a. from 10 percent by weight to 50 percent by weight of an acrylonitrile monomer;
b. from 0.5 percent by weight to 20 percent by weight of a styrene monomer; and
c. from 30 percent by weight to 89.5 percent by weight of a liquid 1,3-butadiene monomer, wherein the acrylonitrile monomer, the styrene monomer, and the liquid 1,3-butadiene monomer are reacted to form a one hundred percent elastomeric randomly branched thermoplastic non-vulcanized terpolymer having a ratio of acrylonitrile to styrene ranging from 3:1 to 8:1, a ratio of the styrene monomer to the butadiene monomer ranging from 0.06:1 to 0.14:1, and a ratio of the acrylonitrile monomer to the butadiene monomer ranging from 0.4:1 to 0.75:1 providing a tensile strength of at least 21 megapascals, a flexibility at temperatures as low as negative 30 degrees Celsius, a resistance to degradation and swelling when in contact with liquid diesel fuel or other liquid non-polar solvents, a compression set for resistance to deformation at temperatures up to 100 degrees Celsius, a modulus of at least 9 megapascals +/−2 megapascals, and a tear strength of 200 ft/lb inch, wherein the one hundred percent elastomeric randomly branched thermoplastic non-vulcanized terpolymer is formed from an emulsion polymerization reaction occurring at a temperature ranging from 5 degrees Celsius to 10 degrees Celsius using a soap, a free radical initiator, a mercaptan, an activator to chemically trigger the free radical initiator under an inert gas, and a terminating agent.

2. The elastomeric randomly branched thermoplastic non-vulcanized terpolymer composition of claim 1, wherein the one hundred percent elastomeric randomly branched thermoplastic non-vulcanized terpolymer composition comprises from thirty percent by weight to forty percent by weight of the acrylonitrile monomer.

3. The elastomeric randomly branched thermoplastic non-vulcanized terpolymer composition of claim 1, further comprising up to fifty percent by weight of a filler.

4. The elastomeric randomly branched thermoplastic non-vulcanized terpolymer composition of claim 3, wherein the filler comprises: ground pecan shells, diamataeous earth, silica, treated silica, silage, cellulosic materials, ground peanut shells, talc, ground coal, ground bagasse, ashes, perlite, clay, calcium carbonate, biomass, or combinations thereof.

5. The elastomeric randomly branched thermoplastic non-vulcanized terpolymer composition of claim 1, further comprising from 0.1 percent by weight to forty percent by weight of an extender oil.

6. The elastomeric randomly branched thermoplastic non-vulcanized terpolymer composition of claim 5, wherein the extender oil comprises: a synthetic oil, an aromatic oil, a naphthenic oil, a hydrocarbon based oil, a polycyclic aromatic hydrocarbon oil, or combinations thereof.

7. The elastomeric randomly branched thermoplastic non-vulcanized terpolymer composition of claim 1, further comprising from 0.1 percent by weight to five percent by weight of an ultraviolet stabilizer, an antioxidant, or combinations thereof.

8. The elastomeric randomly branched thermoplastic non-vulcanized terpolymer composition of claim 7, wherein the antioxidant is a phenolic antioxidant, a phosphite, a bis phenol, an amine, or combinations thereof.

9. The elastomeric randomly branched thermoplastic non-vulcanized terpolymer composition of claim 1, further comprising from 0.1 percent by weight to forty percent by weight of carbon black.

10. The elastomeric randomly branched thermoplastic non-vulcanized terpolymer composition of claim 1, wherein the monomers are cross-linked covalently.

11. An article comprising:
a. from 10 percent by weight to 50 percent by weight of an acrylonitrile monomer;
b. from 0.5 percent by weight to 20 percent by weight of a styrene monomer; and
c. from 30 percent by weight to 89.5 percent by weight of a liquid 1,3-butadiene monomer, wherein the acrylonitrile monomer, the styrene monomer, and the liquid 1,3-butadiene monomer are reacted to form a one hundred percent elastomeric randomly branched thermoplastic non-vulcanized terpolymer having a ratio of acrylonitrile to styrene ranging from 3:1 to 8:1, a ratio of the styrene monomer to the butadiene monomer ranging from 0.06:1 to 0.14:1, and a ratio of the acrylonitrile monomer to the butadiene monomer ranging from 0.4:1 to 0.75:1 providing a tensile strength of at least 21 megapascals, a flexibility at temperatures as low as negative 30 degrees Celsius, a resistance to degradation and swelling when in contact with liquid diesel fuel or other liquid non-polar solvents, a compression set for resistance to deformation at temperatures up to 100 degrees Celsius, a modulus of at least 9 megapascals +/−2 megapascals, and a tear strength of 200 ft/lb inch, wherein the one hundred percent elastomeric randomly branched thermoplastic non-vulcanized terpolymer is formed from an emulsion polymerization reaction occurring at a temperature ranging from 5 degrees Celsius to 10 degrees Celsius using a soap, a free radical initiator, a mercaptan, an activator to chemically trigger the free radical initiator under an inert gas, and a terminating agent.

12. The article of claim 11, wherein the article is a tire, a belt, a non-latex glove, an o-ring, an automotive transmission belt, a roller, a gasket printer's roller, footwear, wire and cable jacketing, roof edging, a tubular hose, a marine impact bumper, an industrial belt, a non-automotive tire, a mining belt, a bearing, a gas mask, or a conduit.

13. The article of claim 11, wherein the monomers are cross-linked covalently.

14. A process for making a thermoplastic non-vulcanized terpolymer of styrene, liquid 1,3-butadiene, and acrylonitrile using an emulsion polymerization processes at a temperature ranging from 1 to 15 degrees Celsius using a free radical initiator, monomers of styrene, monomers of liquid 1,3-butadiene, monomers of acrylonitrile, an activator, and a terminating agent to stop long change polymerization, wherein the emulsion polymerization process comprises:
a. adding to a vessel from 10 percent by weight to 50 percent by weight of an acrylonitrile monomer;
b. adding to the vessel from 0.5 percent by weight to 20 percent by weight of a styrene monomer;
c. adding to the vessel from 30 percent by weight to 89.5 percent by weight of a liquid 1,3-butadiene monomer;
d. adding to the monomers in the vessel, from 60 percent by weight to 70 percent by weight of water, wherein the weight percent of water is based on a weight percent total of the acrylonitrile monomer, the styrene monomer, and the liquid 1,3-butadiene monomer;
e. adding 20 percent by weight of a soap to the vessel, wherein the weight percent of the soap is based on an amount of water in the vessel;
f. adding from 1.5 percent by weight to 3 percent by weight of the free radical initiator to the vessel, wherein the weight percent of the free radical initiator is based on the amount of water in the vessel;
g. adding from 0.3 percent by weight to 1.5 percent by weight of a mercaptan to the vessel, wherein the weight percent of the mercaptan is based on the amount of water in the vessel, forming a mixture;
h. sealing the vessel and pressurizing the vessel under an inert gas to a pressure ranging from 40 psi to 60 psi;
i. agitating the mixture, creating an emulsion;
j. injecting from 1.5 percent by weight to 3 percent by weight of the activator into the emulsion, wherein the activator is a salt in water, wherein the salt is: a cobalt salt, a manganese salt, an iron salt, or combinations thereof, and wherein the salt is added to the emulsion in a 1:1 ratio with the free radical initiator to trigger a polymerization reaction between the monomers;
k. mixing the emulsion to complete polymerization of the monomers, forming a latex with emulsified solids;
l. terminating the polymerization reaction with the terminating agent;
m. releasing pressure from the vessel;
n. stripping unreacted monomers from the latex using at a temperature ranging from 60 degrees Celsius to 93 degrees Celsius without inserting steam into the latex;
o. separating the water from the latex by coagulating the latex with an alum under pressure at an elevated temperature above ambient temperature for no more than 5 minutes, forming a coagulated latex; and
p. precipitating from the coagulated latex an elastomeric thermoplastic non-vulcanized terpolymer having a ratio of acrylonitrile to styrene ranging from 3:1 to 8:1, a ratio of styrene to liquid 1,3-butadiene ranging from 0.06:1 to 0.14:1, and a ratio of acrylonitrile to liquid 1,3-butadiene ranging from 0.4:1 to 0.75:1, providing a tensile strength of at least 21 megapascals, a flexibility at temperatures as low as negative 30 degrees Celsius, a resistance to degradation and swelling when in contact with liquid diesel fuel or other liquid non-polar solvents, a compression set for resistance to deformation at temperatures up to 100 degrees Celsius, a modulus of at least 9 megapascals +/−2 megapascals, and a tear strength of 200 ft/lb inch, wherein the thermoplastic non-vulcanized terpolymer is formed at a temperature ranging from 5 degrees Celsius to 10 degrees Celsius.

15. The method of claim 14, further comprising using from thirty percent by weight to forty percent by weight of the acrylonitrile monomer.

16. The method of claim 14, further comprising using up to fifty percent by weight of a filler.

17. The method of claim 16, further comprising using as the filler: ground pecan shells, diamataeous earth, silica, treated silica, silage, cellulosic materials, ground peanut shells, talc, ground coal, ground bagasse, ashes, perlite, clay, calcium carbonate, biomass, or combinations thereof.

18. The method of claim 14, further comprising using from 0.1 percent by weight to forty percent by weight of an extender oil.

19. The method of claim 18, further comprising using as the extender oil: a synthetic oil, an aromatic oil, a naphthenic oil, a hydrocarbon based oil, a polycyclic aromatic hydrocarbon oil, or combinations thereof.

20. The method of claim 14, further comprising using from 0.1 percent by weight to five percent by weight of an ultraviolet stabilizer, an antioxidant, or combinations thereof.

21. The method of claim 20, wherein the antioxidant is a phenolic antioxidant, a phosphite, a bis phenol, an amine, or combinations thereof.

22. The method of claim 14, further comprising adding from 0.1 percent by weight to forty percent by weight of carbon black to the vessel.

23. The method of claim 14, wherein the free radical initiator is pinane hydroperoxide.

24. The method of claim 14, wherein the activator is a ferrous sulfate.

25. The method of claim 14, wherein the terminating agent is a dodecyl mercaptan.

26. The method of claim 14, wherein the inert gas is nitrogen.

27. The method of claim 14, wherein the agitating of the mixture occurs for a time ranging from ten minutes to thirty minutes at a low temperature ranging from five degrees Celsius to fifteen degrees Celsius.

28. The method of claim 14, further comprising the step of analyzing contents of the vessel during the polymerization reaction to assure homogenous blending occurs and to achieve a target solid in the latex.

29. The method of claim 14, wherein the terminating agent is a diethyl hydroxyl amine.

30. The method of claim 14, further comprising using an elevated pressure from 30,000 psi to 50000 psi, wherein the elevated temperature is from 80 degrees Celsius to 140 degrees Celsius.

31. The method of claim 14, wherein the emulsion polymerization process is a continuous flow polymerization that uses at a flow rate of up to 150 gallons per hour.

32. The method of claim 14, wherein the monomers are cross-linked covalently.
